(19) United States
(12) Patent Application Publication
(10) Pub. No.: US 2024/0159884 A1
(43) Pub. Date: May 16, 2024

(54) Optical Crosstalk Compensation for Optical Sensors

(71) Applicant: Apple Inc., Cupertino, CA (US)

(72) Inventors: Dianbo Guo, San Jose, CA (US); Mengshu Huang, Cupertino, CA (US)

(21) Appl. No.: 18/382,786

(22) Filed: Oct. 23, 2023

Related U.S. Application Data
(60) Provisional application No. 63/425,676, filed on Nov. 15, 2022.

(51) Int. Cl. G01S 7/497; G01S 7/481

(52) U.S. Cl. CPC G01S 7/497; G01S 7/4813

(57) ABSTRACT

An optical sensor module includes a housing, an optical emitter, a photodetector, a sensor circuit, and an optical crosstalk compensation circuit. The optical emitter is configured to emit electromagnetic radiation toward and through the housing. The photodetector is configured to provide a photocurrent to an output node. The photocurrent is responsive to a receipt of first portions of the electromagnetic radiation redirected by an intended target and received through the housing, and second portions of the electromagnetic radiation redirected by an unintended target or received directly from the optical emitter. The sensor circuit is connected to the output node and configured to generate a sensor output. The optical crosstalk compensation circuit is configured to inject a bias current into the output node or the sensor circuit.

### CROSS-REFERENCE TO RELATED APPLICATION

This application is a nonprovisional and claims the benefit under 35 U.S.C. 119(e) of U.S. Provisional Patent Application No. 63/425,676, filed Nov. 15, 2022, the contents of which are incorporated herein by reference as if fully disclosed herein.

### FIELD

The described embodiments relate generally to optical sensors. More particularly, the described embodiments relate to active optical sensors having size or cost constraints. For purposes of this description, an active optical sensor is an optical having both an optical emitter and a photodetector.

### BACKGROUND

Optical sensors may be used to sense a variety of phenomenon. Some optical sensors are constructed as active optical sensors and include both an optical emitter and a photodetector (e.g., a photodiode). Often, the housing of an active optical sensor will include an optically opaque wall that separates the optical emitter from the photodetector. The optically opaque wall prevents electromagnetic radiation emitted by the optical emitter from impinging directly on the photodetector without first impinging on an intended target that is to be sensed.

In some embodiments, an optically opaque wall that separates an optical emitter and a photodetector will extend to a window through which electromagnetic radiation is emitted and received. In these embodiments, electromagnetic radiation can reflect between the two surfaces of the window and impinge on the photodetector before impinging on the intended target. To reduce the likelihood of this happening, an anti-reflective coating (ARC) may be applied to one or both surfaces of the window.

In some embodiments, an optically opaque wall that separates an optical emitter and a photodetector will extend between a first window through which electromagnetic radiation is emitted and a second window through which electromagnetic radiation is received.

All of these options may be relatively larger or more expensive than is desired for a small and/or inexpensive optical sensor.

### SUMMARY

In a first aspect, the present disclosure describes an optical sensor module. The optical sensor module may include a housing, an optical emitter, a photodetector, a sensor circuit, and an optical crosstalk compensation circuit. The optical emitter may be configured to emit electromagnetic radiation toward and through the housing. The photodetector may be configured to provide a photocurrent to an output node. The photocurrent may be responsive to a receipt of first portions of the electromagnetic radiation redirected by an intended target and received through the housing, and second portions of the electromagnetic radiation redirected by an unintended target or received directly from the optical emitter. The sensor circuit may be connected to the output node and configured to generate a sensor output. The optical crosstalk compensation circuit may be configured to inject a bias current into the output node or the sensor circuit.

In another aspect, the present disclosure describes an optical sensor. The optical sensor may include an optical emitter, a photodiode, a sensor circuit, and an optical crosstalk compensation circuit. The optical emitter may be configured to emit electromagnetic radiation. The photodiode may be configured to provide a photocurrent to an output node. The photocurrent may be responsive to a receipt of first portions of the electromagnetic radiation redirected by an intended target, and second portions of the electromagnetic radiation redirected by an unintended target or received directly from the optical emitter. The sensor circuit may be connected to the output node and configured to generate a sensor output. The optical crosstalk compensation circuit may be connected to at least one of the output node or the sensor circuit and configured to provide a bias to the at least one of the output node or the sensor circuit.

In another aspect of the present disclosure, a method of compensating for optical crosstalk between an optical emitter and a photodiode are described. The method may include driving the optical emitter to cause the optical emitter to emit electromagnetic radiation; receiving portions of the electromagnetic radiation at the photodiode; generating a photocurrent responsive to the received portions of the electromagnetic radiation; generating a bias; compensating for the optical crosstalk between the optical emitter and the photodiode by adjusting the photocurrent using the bias; and converting the adjusted photocurrent to a voltage.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example block diagram of an optical sensor;

FIGS. 2A & 2B show an example of an optical sensor module;

FIG. 3 shows a first example schematic of an optical sensor;

FIG. 4 shows a second example schematic of an optical sensor;

FIG. 5 shows a third example schematic of an optical sensor;

FIG. 6 shows an example method of reducing optical crosstalk between an optical emitter and a photodiode;

FIGS. 7A & 7B show an example of an electronic device including an optical sensor; and

FIG. 8 shows an example electrical block diagram of an electronic device.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments as defined by the appended claims.

The optical sensors described in the Background include an optically opaque wall positioned between an optical emitter and a photodetector of an active optical sensor. To reduce the size and/or lower the cost of an optical sensor, the optically opaque wall may be eliminated and the optical emitter and photodetector may be positioned in closer proximity. The cost of an optical sensor may also be reduced by eliminating the application of an ARC to one or both surfaces of a window or windows through which electromagnetic radiation is emitted or received. The optical crosstalk that results from such optimizations may be eliminated or reduced by means of an optical crosstalk compensation circuit, as described herein.

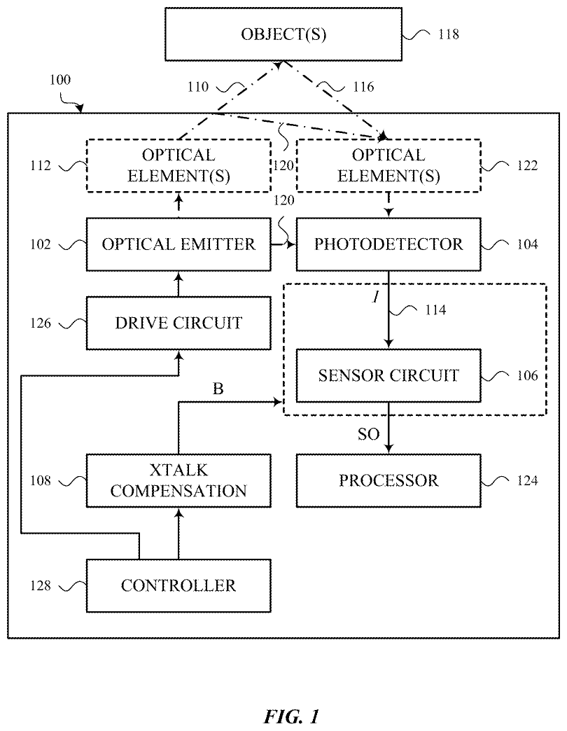

These and other aspects are described with reference to FIGS. 1-8. However, those skilled in the art will readily appreciate that the detailed description given herein with respect to these figures is for explanatory purposes only and should not be construed as limiting.

Directional terminology, such as “top”, “bottom”, “upper”, “lower”, “front”, “back”, “over”, “under”, “above”, “below”, “left”, or “right” is used with reference to the orientation of some of the components in some of the figures described below. Because components in various embodiments can be positioned in a number of different orientations, directional terminology is used for purposes of illustration only and is usually not limiting. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

FIG. 1 shows an example block diagram of an optical sensor 100. As shown, the optical sensor 100 may include an optical emitter 102, a photodetector 104, a sensor circuit 106, and an optical crosstalk (XTALK) compensation circuit 108.

The optical emitter 102 may include a light emitting diode (LED), a laser, or some other type of optical emitter. The optical emitter 102 may be driven by a drive circuit 126, and caused to emit electromagnetic radiation by the drive circuit 126. The electromagnetic radiation 110 emitted by the optical emitter 102 may be emitted as a flood of electromagnetic radiation, a beam of electromagnetic radiation, or a pattern of electromagnetic radiation. The electromagnetic radiation 110 may be visible electromagnetic radiation (e.g., red, blue, or green light) or invisible electromagnetic radiation (e.g., infrared (IR) or ultraviolet (UV) electromagnetic radiation). The optical emitter 102 may include a single or multiple elements (e.g., a single or multiple LEDs or lasers) that emit electromagnetic radiation of the same or different wavelength(s), at the same or different time(s). Optionally, one or more optical elements 112, such as one or more lenses, filters, beam directors (i.e., optical elements that passively alter, or actively steer, the direction of a beam of electromagnetic radiation), beam shapers (i.e., optical elements that shape the footprint or waist of a beam of electromagnetic radiation), beam splitters, diffusers, and so on may be positioned in the optical emission path of the optical emitter 102.

The photodetector 104 may include a photodiode or some other type of photodetector. The photodetector 104 may be configured to provide a photocurrent (I) to an output node 114. The photocurrent may be produced in response to the photodetector's receipt of 1) first portions 116 of electromagnetic radiation 110 emitted by the optical emitter 102, which portions 116 are redirected by an intended target that is to be sensed by the optical sensor 100 (e.g., one or more objects 118 external to a module in which the optical sensor 100 is housed), and 2) second portions 120 of the electromagnetic radiation 110 that are redirected by an unintended target (e.g., a housing for the module in which the optical sensor 100 is housed) or received directly from the optical emitter 102. The photodetector 104 may include a single or multiple elements (e.g., a single or multiple photodiodes) that receive electromagnetic radiation at the same or different times. Optionally, one or more optical elements 122, such as one or more lenses or filters, may be positioned in an intended optical reception path of the photodetector 104.

The sensor circuit 106 may be connected to the output node 114 and configured to generate a sensor output (SO). When the photodetector 104 receives electromagnetic radiation 116 and/or 120 and provides a photocurrent to the output node 114, the sensor circuit 106 may generate a sensor output corresponding to the received electromagnetic radiation 116 and/or 120. When the intended target (e.g., one or more objects 118) moves with respect to the optical emitter 102, or vice versa, the intensity, frequency, or phase of the electromagnetic radiation 116 may change, producing a corresponding change in the sensor output. A processor 124 or other component may analyze the amplitude, frequency, or phase of the sensor output and determine one or more characteristics of the one or more objects 118, such as a movement speed, movement direction, surface quality, number, concentration, or size of the one or more objects 118.

As previously mentioned, some or all of the electromagnetic radiation 110 emitted by the optical emitter 102 may impinge on an intended target that is to be sensed by the optical sensor 100 (e.g., the one or more objects 118), and portions 116 of the electromagnetic radiation 110 may be redirected (e.g., reflected or scattered) toward the photodetector 104. Upon sensing the redirected portions 116 of the electromagnetic radiation, the photodetector 104 may provide a photocurrent (I) to the output node 114. However, a portion 120 of the electromagnetic radiation 110 may be redirected toward the photodetector 104 by an unintended target, or a portion 120 of the electromagnetic radiation 110 may be directed toward the photodetector 104 by the optical emitter 102. These portions 120 of the electromagnetic radiation may be unwanted, and are referred to herein as optical crosstalk. Optical crosstalk may cause the photodetector 104 to produce a photocurrent in the absence of an intended target. In the presence of an intended target (e.g., the one or more objects 118), optical crosstalk may cause the photodetector 104 to produce a photocurrent that is great enough to saturate the sensor circuit 106. Even in the absence of an intended target, optical crosstalk may in some cases cause the photodetector 104 to produce a photocurrent that is great enough to saturate the sensor circuit 106. The optical crosstalk compensation circuit 108 may be used to compensate for the optical crosstalk (e.g., reduce or eliminate effects of the optical crosstalk on the photocurrent).

The optical crosstalk compensation circuit 108 may be connected to at least one of the output node 114 or the sensor circuit 106. The optical crosstalk compensation circuit 108 may be configured to provide a bias (B) to at least one of the sensor circuit 106 or a node or circuit component upstream from the sensor circuit 106. Depending on the embodiment, the bias may take the form of a bias current, a bias voltage or a bias value. The bias may adjust the photocurrent to compensate for optical crosstalk between the optical emitter 102 and the photodetector 104. In some embodiments, the optical crosstalk compensation circuit 108 may generate the bias (e.g., generate a bias current or bias voltage). In other embodiments, the optical crosstalk compensation circuit 108 may receive and propagate the bias (e.g., the optical crosstalk compensation circuit 108 may receive the bias at an input and propagate the bias over one or more conductors).

An optional controller 128 may be coupled to the drive circuit 126 and the optical crosstalk compensation circuit 108, and may synchronize operation of the drive circuit 126 and the optical crosstalk compensation circuit 108.

In some embodiments, all of the components shown in FIG. 1 may be housed within a single module or mounted on a single substrate. In some embodiments, the components may be distributed across different modules, substrates, or chips. For example, in some embodiments, the controller 128, processor 124, or portions of the optical crosstalk compensation circuit 108 may be provided on or in one or more structures that are separate from a module, substrate, or chip including the remaining components.

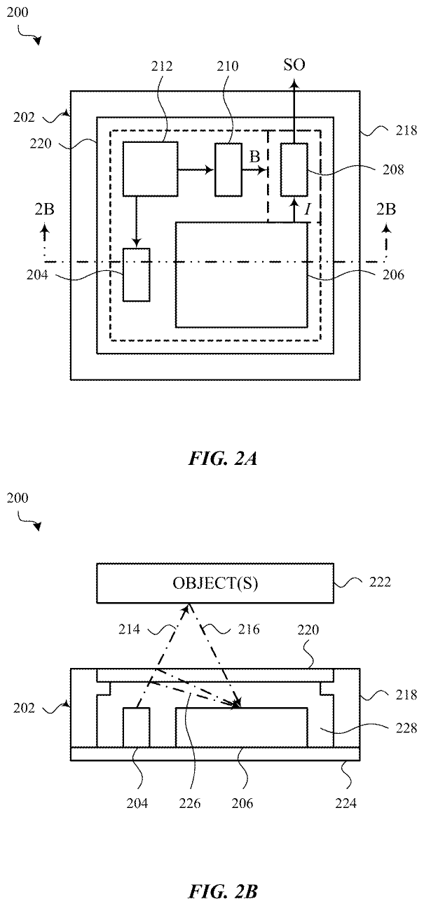

FIGS. 2A and 2B show an example of an optical sensor module 200. The module 200 may include a housing 202, an optical emitter 204, a photodetector 206, a sensor circuit 208, an optical crosstalk compensation circuit 210, and an optional drive circuit and controller 212.

The optical emitter 204 may be positioned or otherwise configured to emit electromagnetic radiation 214 toward and through the housing 202. The photodetector 206 may be positioned or otherwise configured to receive redirected portions 216 of the electromagnetic radiation through the housing 202, redirected portions 226 of the electromagnetic radiation within the housing 202, and/or portions of the electromagnetic radiation 214 received directly from the optical emitter 204.

In some embodiments, the housing 202 may include a frame 218 and a window 220, with the frame 218 supporting the window 220. The window 220 may be transparent to the electromagnetic radiation 214 emitted by the optical emitter 204, and transparent to the portion 216 of the electromagnetic radiation 214 that is redirected by an intended target (e.g., one or more objects 222 external to the module 200) and received by the photodetector 206. The window 220 may be transparent, translucent, or opaque to electromagnetic radiation that is outside the wavelength or range of wavelengths emitted by the optical emitter 204. In some embodiments, the window 220 may include glass or plastic. In some embodiments, the frame 218 may be plastic or metal.

The optical emitter 204 and photodetector 206 may be positioned within a same cavity 228 within the housing 202, but in alternative embodiments may be positioned in different cavities.

The optical emitter may emit electromagnetic radiation 214 toward and through the housing 202 or window 220, and the photodetector 206 may receive, through the housing 202 or window 220, portions 216 of the electromagnetic radiation 214 that are redirected by one or more objects 222. In alternative embodiments, the optical emitter 204 and photodetector 206 may emit and receive electromagnetic radiation through a same set of two or more windows; or the optical emitter 204 and photodetector 206 may emit and receive electromagnetic radiation through different sets of one or more windows, with the different sets of one or more windows being disjoint or overlapping. In additional alternative embodiments, the frame 218 and the window 220 may be replaced by a monolithic housing that is transparent to the electromagnetic radiation 214, 216 emitted by the optical emitter 204 and received by the photodetector 206.

In some embodiments, the optical sensor module 200 may include a substrate 224, and the optical emitter 204 and photodetector 206 may be mounted on the substrate 224. The substrate 224 may be attached to the housing 202. Alternatively, the optical emitter 204 and photodetector 206 may be mounted on respective different substrates that are attached to the housing 202. In either case, the photodetector 206 may be laterally offset from the optical emitter 204, although it need not be and may be positioned closer to or farther from the window 220.

The optical emitter 204, photodetector 206, sensor circuit 208, and optical crosstalk compensation circuit 210 may form an optical sensor. In some embodiments, the optical emitter 204, photodetector 206, sensor circuit 208, and optical crosstalk compensation circuit 210 may be configured similarly to how these components are configured in the optical sensor described with reference to FIG. 1.

As described with reference to FIG. 1, the optical crosstalk compensation circuit 210 may be configured to provide a bias (B) to the sensor circuit 208, or to a node or circuit component upstream from the sensor circuit 208. Depending on the embodiment, the bias may take the form of a bias current, a bias voltage or a bias value. The bias may adjust a photocurrent provided by the photodetector 206, to compensate for optical crosstalk between the optical emitter 204 and the photodetector 206. In some embodiments, the optical crosstalk compensation circuit 210 may generate the bias (e.g., generate a bias current or bias voltage). In other embodiments, the optical crosstalk compensation circuit 210 may receive and propagate the bias (e.g., the optical crosstalk compensation circuit 210 may receive the bias at an input to the optical sensor module 200 (e.g., at an electrical contact or electrical connector on, or extending from, the housing 202) and propagate the bias over one or more conductors).

The optical crosstalk compensation circuit 210 may be calibrated to compensate for some or all of the optical crosstalk between the optical emitter 204 and the photodetector 206 (e.g., portions 226 of the electromagnetic radiation 214). The optical crosstalk may include, for example, portions 226 of the electromagnetic radiation 214 that are redirected toward the photodetector 206 by unintended targets, such as the window 220. The optical crosstalk may additionally or alternatively include, for example, portions 226 of the electromagnetic radiation 214 that are received directly from the optical emitter 204.

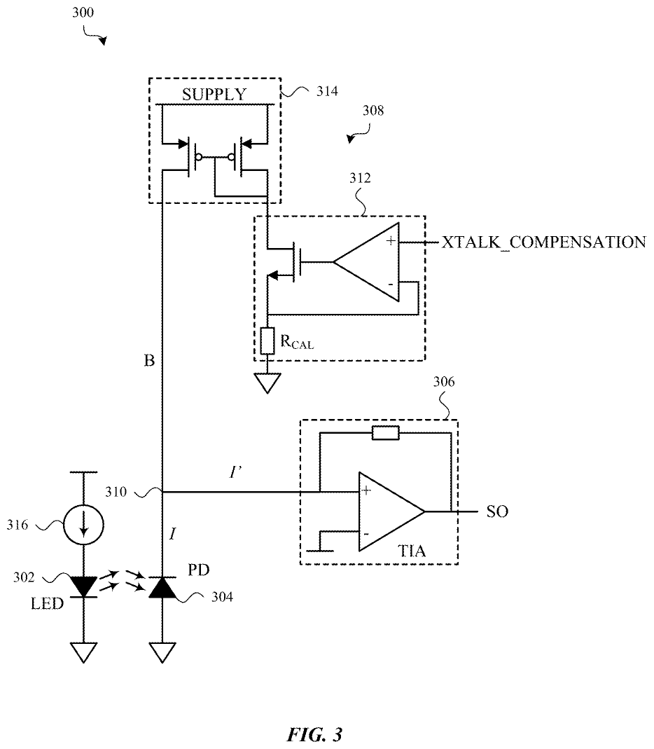

FIG. 3 shows a first example schematic of an optical sensor 300. In some embodiments, the optical sensor 300 may be the optical sensor described with reference to FIG. 1 or 2.

The optical sensor 300 may include an optical emitter 302, a photodetector 304 (e.g., a photodiode (PD)), a sensor circuit 306 (e.g., a transimpedance amplifier (TIA)), and an optical crosstalk compensation circuit 308. In some embodiments, the optical emitter 302, photodetector 304, sensor circuit 306, and optical crosstalk compensation circuit 308 may be configured as described with reference to FIG. 1 or 2.

The optical emitter 302 may emit electromagnetic radiation under control of a drive circuit 316. Some or all of the emitted electromagnetic radiation (e.g., a first portion of the electromagnetic radiation) may impinge on an intended target (e.g., one or more objects external to a module including the optical sensor 300) and be redirected (e.g., reflected or scattered) toward the photodetector 304. Upon sensing the redirected portions of the electromagnetic radiation, the photodetector 304 may provide a photocurrent (I) to an output node 310. Other portions of the emitted electromagnetic radiation (e.g., a second portion of the electromagnetic radiation) may 1) impinge on one or more unintended targets (e.g., one or more objects internal to a module including the optical sensor, or one or more objects forming a housing of the module, such as surfaces of (or imperfections in) a window through which the electromagnetic radiation passes) and be redirected toward the photodetector 304, or 2) be received at the photodetector 304 directly from the optical emitter 302. The second portion of the electromagnetic radiation may increase the photocurrent that the photodetector 304 provides to the output node 310 or cause the photodetector 304 to provide a photocurrent to the output node 310 in the absence of an intended target. The portion of the photocurrent that is attributable to the second portion of the electromagnetic radiation may be more or less static, and may present as DC noise in the photocurrent provided to the output node 310.

The output node 310 may be connected to an input of the sensor circuit 306 (e.g., to an input of a TIA). In some cases, DC noise—alone or in combination with a portion of the photocurrent that is attributable to the first portion of the electromagnetic radiation—may saturate the sensor circuit 306 (e.g., saturate the TIA). When the sensor circuit 306 saturates, fluctuations in the photocurrent that are attributable to the first portion of the electromagnetic radiation may not be detected in the sensor output (SO) generated by the sensor circuit 306.

To offset the DC noise component of the photocurrent generated by the photodetector 304, the optical crosstalk compensation circuit 308 may provide a bias (B) to at least one of the output node 310 or the sensor circuit 306. As shown in FIG. 3, the optical crosstalk compensation circuit 308 may generate a bias current and provide the bias current to (i.e., inject the bias current into) the output node 310. The bias current (B) may be subtracted from the photocurrent (I) at the output node, such that an adjusted photocurrent (I′) is provided to an input of the sensor circuit 306. In this manner, the bias current may reduce the likelihood that the sensor circuit 306 saturates as a result of DC noise in the photocurrent (I).

By way of example, the optical crosstalk compensation circuit 308 may be or include a voltage-to-current converter. One example of a voltage-to-current converter is shown in FIG. 3 and includes an operational amplifier (op amp) 312 that drives one leg of a current mirror 314, with the other leg of the current mirror 314 providing a bias current (B) to the output node 310. The value of the bias current (B) can be controlled, in part, selecting the value of the voltage (i.e., XTALK_COMPENSATION) provided as an input to the op amp 312.

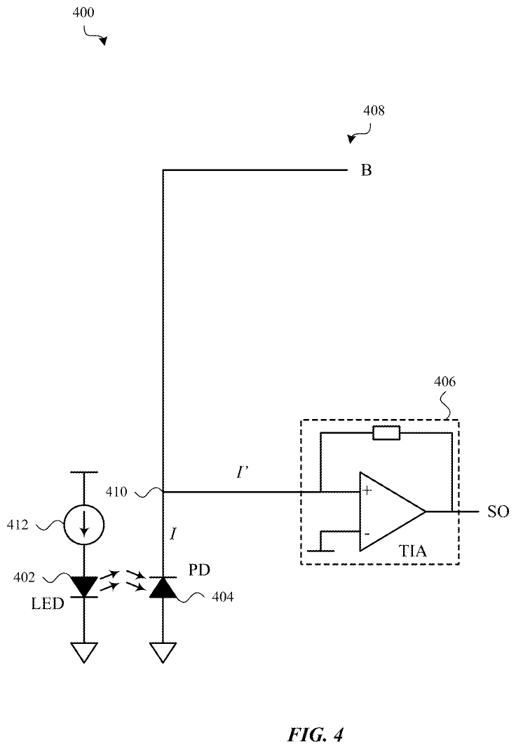

FIG. 4 shows a second example schematic of an optical sensor 400. In some embodiments, the optical sensor 400 may be the optical sensor described with reference to FIG. 1 or 2.

The optical sensor 400 may include an optical emitter 402, a photodetector 404 (e.g., a PD), a sensor circuit 406 (e.g., a TIA), and an optical crosstalk compensation circuit 408. The optical sensor 400 may also include a drive circuit 412 that is operable to drive the optical emitter 402. In some embodiments, the optical emitter 402, photodetector 404, and sensor circuit 406 may be configured as described with reference to any of FIGS. 1-3. The optical crosstalk compensation circuit 408 and drive circuit 412 may be configured as described with reference to FIG. 1 or 2.

The optical sensor 400 may function similarly to the optical sensor described with reference to FIG. 3, with a difference being that a bias (B) is generated elsewhere (e.g., off-module or off-chip) and then propagated by the optical crosstalk compensation circuit 408. For example, the optical crosstalk compensation circuit 408 may receive a bias current as an input and propagate the bias to an output node 410 of the photodetector 404.

The optical crosstalk compensation circuit 408 described with reference to FIG. 4 can reduce the amount of circuitry that needs to be included in a module or similar device, but may allow a relatively greater amount of noise to be picked up by the bias as it is propagated from an off-module or off-chip circuit to the optical crosstalk compensation circuit 408.

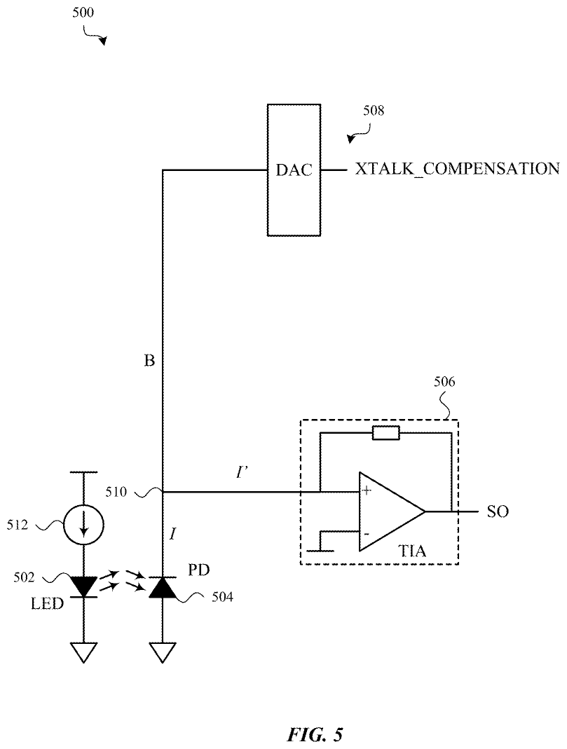

FIG. 5 shows a third example schematic of an optical sensor 500. In some embodiments, the optical sensor 500 may be the optical sensor described with reference to FIG. 1 or 2.

The optical sensor 500 may include an optical emitter 502, a photodetector 504 (e.g., a PD), a sensor circuit 506 (e.g., a TIA), and an optical crosstalk compensation circuit 508. The optical sensor 500 may also include a drive circuit 512 that is operable to drive the optical emitter 502. In some embodiments, the optical emitter 502, photodetector 504, and sensor circuit 506 may be configured as described with reference to any of FIGS. 1-3. The optical crosstalk compensation circuit 508 and drive circuit 512 may be configured as described with reference to FIG. 1 or 2.

The optical sensor 500 may function similarly to the optical sensor described with reference to FIG. 3, with a difference being that a bias (B) is generated by a digital-to-analog converter (DAC). In the optical sensor 500, XTALK_COMPENSATION is a digital input (e.g., a multi-bit input) that is provided to the DAC to generate an analog output in the form of a bias current (B).

The optical crosstalk compensation circuit 508 can reduce interference in the bias (B) as a result of XTALK_COMPENSATION being a digital value that is relatively more immune to interference than an analog current or voltage. However, the granularity of bias control provided by the optical crosstalk compensation circuit 508 may be somewhat less than granularity of bias control provided by the optical crosstalk compensation circuits described with reference to FIGS. 3 and 4.

Although the optical crosstalk compensation circuits described with reference to FIGS. 3-5 provide bias currents to an output node of a photodetector, an optical crosstalk compensation circuit may alternatively provide a bias voltage, and in some embodiments may provide a bias voltage to a sensor circuit having a different configuration than the TIAs shown in FIGS. 3-5.

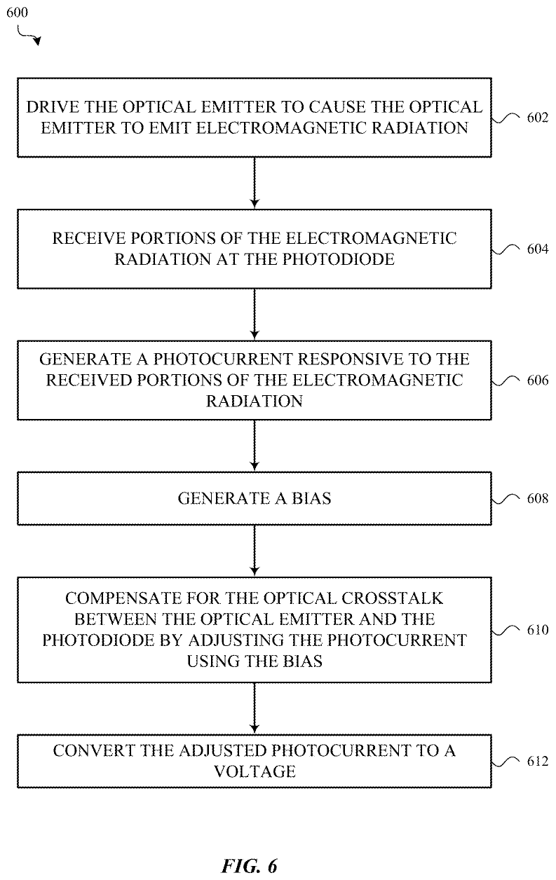

FIG. 6 shows an example method 600 of reducing optical crosstalk between an optical emitter and a photodiode. The method 600 may be performed, for example, using one of the optical sensors or optical sensor modules described herein.

At 602, the method 600 may include driving the optical emitter to cause the optical emitter to emit electromagnetic radiation. The operation(s) at 602 may be performed by a drive circuit, under control of a controller, as described herein.

At 604, the method 600 may include receiving portions of the electromagnetic radiation at the photodiode (or more generally, a photodetector).

At 606, the method 600 may include generating a photocurrent responsive to the received portions of the electromagnetic radiation. The operation(s) at 606 may be performed by the photodiode (or photodetector), as described herein.

At 608, the method 600 may include generating a bias, such as a bias current or a bias voltage. The operation(s) at 608 may be performed by an optical crosstalk compensation circuit, as described herein.

At 610, the method 600 may include compensating for the optical crosstalk between the optical emitter and the photodiode by adjusting the photocurrent using the bias. In some embodiments, the bias may be a bias current, and adjusting the photocurrent, using the bias, may include subtracting the bias current from the photocurrent. The operation(s) at 610 may be performed at an output node of the photodiode (or a photodetector), or by a summing or subtracting circuit, or by other circuitry, as described herein.

At 612, the method 600 may include converting the adjusted photocurrent to a voltage. The operation(s) at 612 may be performed by a sensor circuit, such as a TIA, as described herein.

The method 600 may be variously embodied, extended, or adapted, as described in the following paragraphs and elsewhere in this description.

In some embodiments, the operations at 602-612 may be performed, at times, to detect the presence of one or more objects, or to determine one or more characteristics of the one or more objects (e.g., a movement speed (e.g., a linear speed or rotational speed), movement direction (e.g., a linear direction or direction of rotation), surface quality, number, concentration, or size of the one or more objects). In some embodiments, the operations at 602-612 may be performed, at times, to calibrate the bias under a no target condition. A “no target condition” is a state in which objects are far enough from the optical emitter that little or no portion of the electromagnetic radiation emitted by the optical emitter is redirected to the photodiode (or photodetector) by an intended or dynamic target.

In some embodiments, the method 600 may include, under a no target condition, emitting the electromagnetic radiation and receiving the portions of the electromagnetic radiation; determining the voltage produced by converting the adjusted photocurrent differs from a calibrated value; and calibrating the bias in response to determining the voltage produced by converting the adjusted photocurrent differs from the calibrated value. The calibration of the bias may move the voltage to (or toward) a value that maximizes the effective range of a sensor circuit, so that the sensor circuit is less likely to saturate under a range of possible photocurrents.

In some embodiments, the method 600 may include, under a no target condition, emitting the electromagnetic radiation and receiving the portions of the electromagnetic radiation; determining the voltage produced by converting the photocurrent differs from a calibrated value by more than a threshold amount; and calibrating the bias in response to determining the voltage produced by converting the photocurrent differs from the calibrated value by more than the threshold amount. These embodiments may result in fewer calibrations than the previously described embodiments, which may save processing time, power, or other resources while operating in a mode that is close enough to fully calibrated.

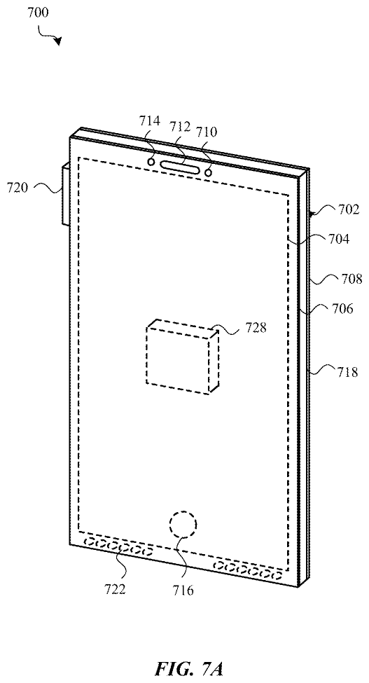

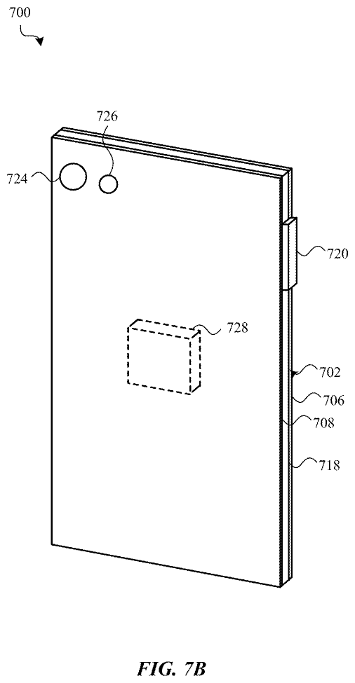

FIGS. 7A and 7B show an example of an electronic device 700 including an optical sensor or optical sensor module, such as the optical sensor or optical sensor module described with reference to any of FIGS. 1-5. The device's dimensions and form factor, including the ratio of the length of its long sides to the length of its short sides, suggest that the device 700 is a mobile phone (e.g., a smartphone). However, the device's dimensions and form factor are arbitrarily chosen, and the device 700 could alternatively be any portable electronic device including, for example a mobile phone, tablet computer, portable computer, portable music player, health monitor device, portable terminal, vehicle navigation system, robot navigation system, wearable device (e.g., a head-mounted display (HMD), glasses, watch, earphone or earbud, and so on), or other portable or mobile device. The device 700 could also be a device that is semi-permanently located (or installed) at a single location. FIG. 7A shows a front isometric view of the device 700, and FIG. 7B shows a rear isometric view of the device 700. The device 700 may include a housing 702 that at least partially surrounds a display 704. The housing 702 may include or support a front cover 706 or a rear cover 708. The front cover 706 may be positioned over the display 704, and may provide a window through which the display 704 may be viewed. In some embodiments, the display 704 may be attached to (or abut) the housing 702 and/or the front cover 706. In alternative embodiments of the device 700, the display 704 may not be included and/or the housing 702 may have an alternative configuration.

The display 704 may include one or more light-emitting elements and may be configured, for example, as a light-emitting diode (LED) display, an organic LED (OLED), a liquid crystal display (LCD), an electroluminescent (EL) display, or another type of display. In some embodiments, the display 704 may include, or be associated with, one or more touch and/or force sensors that are configured to detect a touch and/or a force applied to a surface of the front cover 706.

The various components of the housing 702 may be formed from the same or different materials. For example, the sidewall 718 may be formed using one or more metals (e.g., stainless steel), polymers (e.g., plastics), ceramics, or composites (e.g., carbon fiber). In some cases, the sidewall 718 may be a multi-segment sidewall including a set of antennas. The antennas may form structural components of the sidewall 718. The antennas may be structurally coupled (to one another or to other components) and electrically isolated (from each other or from other components) by one or more non-conductive segments of the sidewall 718. The front cover 706 may be formed, for example, using one or more of glass, a crystal (e.g., sapphire), or a transparent polymer (e.g., plastic) that enables a user to view the display 704 through the front cover 706. In some cases, a portion of the front cover 706 (e.g., a perimeter portion of the front cover 706) may be coated with an opaque ink to obscure components included within the housing 702. The rear cover 708 may be formed using the same material(s) that are used to form the sidewall 718 or the front cover 706. In some cases, the rear cover 708 may be part of a monolithic element that also forms the sidewall 718 (or in cases where the sidewall 718 is a multi-segment sidewall, those portions of the sidewall 718 that are non-conductive). In still other embodiments, all of the exterior components of the housing 702 may be formed from a transparent material, and components within the device 700 may or may not be obscured by an opaque ink or opaque structure within the housing 702.

The front cover 706 may be mounted to the sidewall 718 to cover an opening defined by the sidewall 718 (i.e., an opening into an interior volume in which various electronic components of the device 700, including the display 704, may be positioned). The front cover 706 may be mounted to the sidewall 718 using fasteners, adhesives, seals, gaskets, or other components.

A display stack or device stack (hereafter referred to as a “stack”) including the display 704 may be attached (or abutted) to an interior surface of the front cover 706 and extend into the interior volume of the device 700. In some cases, the stack may include a touch sensor (e.g., a grid of capacitive, resistive, strain-based, ultrasonic, or other type of touch sensing elements), or other layers of optical, mechanical, electrical, or other types of components. In some cases, the touch sensor (or part of a touch sensor system) may be configured to detect a touch applied to an outer surface of the front cover 706 (e.g., to a display surface of the device 700).

In some cases, a force sensor (or part of a force sensor system) may be positioned within the interior volume below and/or to the side of the display 704 (and in some cases within the device stack). The force sensor (or force sensor system) may be triggered in response to the touch sensor detecting one or more touches on the front cover 706 (or a location or locations of one or more touches on the front cover 706), and may determine an amount of force associated with each touch, or an amount of force associated with the collection of touches as a whole. Alternatively, the force sensor (or force sensor system) may trigger operation of the touch sensor (or touch sensory system in response to detecting a force on the front cover 706. In some cases, the force sensor (or force sensor system) may be used to determine the locations of touches on the front cover 706, and may thereby function as a touch sensor (or touch sensor system).

As shown primarily in FIG. 7A, the device 700 may include various other components. For example, the front of the device 700 may include one or more front-facing cameras 710, speakers 712, microphones, or other components 714 (e.g., audio, imaging, and/or sensing components) that are configured to transmit or receive signals to/from the device 700. In some cases, a front-facing camera 710, alone or in combination with other sensors, may be configured to operate as a bio-authentication or facial recognition sensor. The device 700 may also include various input and/or output devices 716, which may be accessible from the front surface (or display surface) of the device 700. In some cases, the front-facing camera 710, I/O devices 716, and/or other sensors of the device 700 may be integrated with a display stack of the display 704 and moved under or partially under the display 704.

The device 700 may also include buttons or other input devices positioned along the sidewall 718 and/or on a rear surface of the device 700. For example, a volume button or multipurpose button 720 may be positioned along the sidewall 718, and in some cases may extend through an aperture in the sidewall 718. Additionally or alternatively, and especially if the device 700 were to be configured as a watch, the button 720 may be replaced or supplemented with a crown. The sidewall 718 may include one or more ports 722 that allow air, but not liquids, to flow into and out of the device 700. In some embodiments, one or more sensors may be positioned in or near the port(s) 722. For example, an ambient pressure sensor, ambient temperature sensor, internal/external differential pressure sensor, gas sensor, particulate matter sensor, or air quality sensor may be positioned in or near a port 722.

In some embodiments, the rear surface of the device 700 may include a rear-facing camera 724 or other form of optical sensor (see FIG. 7B). A flash or light source 726 may also be positioned along the rear of the device 700 (e.g., near the rear-facing camera). In some cases, the rear surface of the device 700 may include multiple rear-facing cameras.

In some cases, one or more of the camera 710, components 714, I/O devices 716, button 720 (or crown), or camera 724 may include an optical sensor or optical sensor module, configured as described herein. The optical sensor may be used for visible (e.g., red, blue, or green) or invisible (e.g., IR or UV) illumination of a person (e.g., a face or finger) or another object or objects (e.g., particles suspended in a gas). In some embodiments, the optical sensor may emit and receive electromagnetic radiation through the front cover 706 or rear cover 708. The optical sensor may be used for sensing characteristics (e.g., the presence, position, or movement) of a user, one or more objects in an ambient environment of the device 700 (including, for example, particles), or one or more objects of the device 700 (e.g., movement of a shaft attached to a crown).

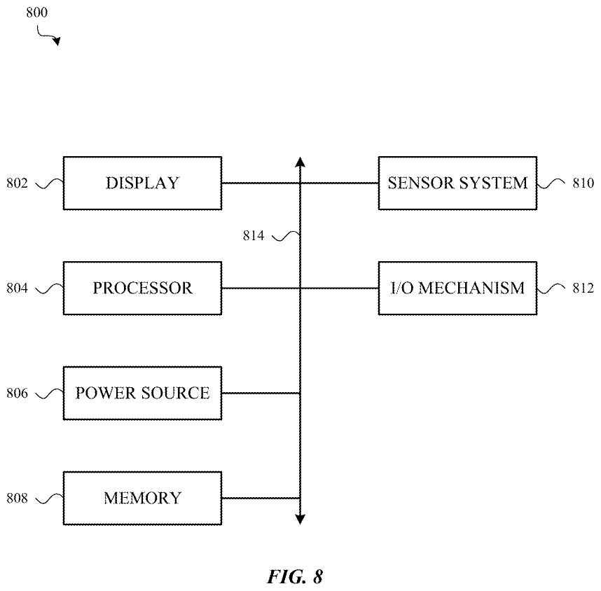

FIG. 8 shows a sample electrical block diagram of an electronic device 800, which electronic device may in some cases take the form of the device described with reference to FIGS. 7A and 7B and/or include the optical sensor module or optical sensor described with reference to any of FIGS. 1-5. The electronic device 800 may include a display 802 (e.g., a light-emitting display), a processor 804, a power source 806, a memory 808 or storage device, a sensor system 810, or an input/output (I/O) mechanism 812. The processor 804 may control some or all of the operations of the electronic device 800. The processor 804 may communicate, either directly or indirectly, with some or all of the other components of the electronic device 800. For example, a system bus or other communication mechanism 814 can provide communication between the display 802, the processor 804, the power source 806, the memory 808, the sensor system 810, and the I/O mechanism 812.

The processor 804 may be implemented as any electronic device capable of processing, receiving, or transmitting data or instructions, whether such data or instructions is in the form of software or firmware or otherwise encoded. For example, the processor 804 may include a microprocessor, a central processing unit (CPU), an application-specific integrated circuit (ASIC), a digital signal processor (DSP), a controller, or a combination of such devices. As described herein, the term “processor” is meant to encompass a single processor or processing unit, multiple processors, multiple processing units, or other suitably configured computing element or elements.

It should be noted that the components of the electronic device 800 can be controlled by multiple processors. For example, select components of the electronic device 800 (e.g., the sensor system 810) may be controlled by a first processor and other components of the electronic device 800 (e.g., the display 802) may be controlled by a second processor, where the first and second processors may or may not be in communication with each other.

The power source 806 can be implemented with any device capable of providing energy to the electronic device 800. For example, the power source 806 may include one or more batteries or rechargeable batteries. Additionally or alternatively, the power source 806 may include a power distribution system, power cord connector, or wireless charging circuit that connects the electronic device 800 to another power source, such as a wall outlet.

The memory 808 may store electronic data that can be used by the electronic device 800. For example, the memory 808 may store electrical data or content such as, for example, an operating system, computer programs, device settings and user preferences, timing signals, control signals, data structures or databases, audio or video files, documents or applications, and so on. The memory 808 may include any type of memory. By way of example only, the memory 808 may include random access memory, read-only memory, flash memory, removable memory, other types of storage elements, or combinations of such memory types.

The electronic device 800 may also include one or more sensor systems 810 positioned almost anywhere on the electronic device 800. The sensor system(s) 810 may be configured to sense one or more type of parameters, such as but not limited to, light; touch; force; heat; movement; relative motion; biometric data (e.g., biological parameters) of a user; particulate matter concentration; air quality; proximity; position; connectedness; and so on. By way of example, the sensor system(s) 810 may include an optical sensor, a heat sensor, a position sensor, an accelerometer, a pressure transducer, a gyroscope, a magnetometer, a health monitoring sensor, a particulate matter sensor, an air quality sensor, and so on. Additionally, the one or more sensor systems 810 may utilize any suitable sensing technology, including, but not limited to, optical, magnetic, capacitive, ultrasonic, resistive, acoustic, piezoelectric, or thermal technologies.

The I/O mechanism 812 may transmit or receive data from a user or another electronic device. The I/O mechanism 812 may include the display 802, a touch sensing input surface, a crown, one or more buttons (e.g., a graphical user interface “home” button), one or more cameras, one or more microphones or speakers, one or more ports such as a microphone port, and/or a keyboard. Additionally or alternatively, the I/O mechanism 812 may transmit electronic signals via a communications interface, such as a wireless, wired, and/or optical communications interface. Examples of wireless and wired communications interfaces include, but are not limited to, cellular and Wi-Fi communications interfaces.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. An optical sensor module, comprising:
a housing;
an optical emitter configured to emit electromagnetic radiation toward and through the housing;
a photodetector configured to provide a photocurrent to an output node, the photocurrent responsive to a receipt of,
first portions of the electromagnetic radiation redirected by an intended target and received through the housing; and
second portions of the electromagnetic radiation redirected by an unintended target or received directly from the optical emitter;
a sensor circuit connected to the output node and configured to generate a sensor output; and
an optical crosstalk compensation circuit configured to inject a bias current into the output node or the sensor circuit.

2. The optical sensor module of claim 1, further comprising:
a substrate; wherein,
the optical emitter and the photodetector are mounted on the substrate; and
the substrate is attached to the housing.

3. The optical sensor module of claim 2, wherein the photodetector is laterally offset from the optical emitter.

4. The optical sensor module of claim 1, wherein:
the housing comprises a frame and a window, the frame supporting the window;
the window is transparent to the electromagnetic radiation;
the optical emitter emits the electromagnetic radiation toward and through the window; and
the photodetector receives the first portions of the electromagnetic radiation through the window.

5. The optical sensor module of claim 1, wherein the optical crosstalk compensation circuit generates the bias current.

6. The optical sensor module of claim 1, wherein the optical crosstalk compensation circuit receives the bias current at an input to the optical sensor module and propagates the bias current.

7. The optical sensor module of claim 1, wherein:
the sensor circuit comprises a transimpedance amplifier;
the output node is electrically connected to an input of the transimpedance amplifier; and
the optical crosstalk compensation circuit injects the bias current into the output node.

8. The optical sensor module of claim 1, wherein the optical emitter and the photodetector are positioned within a same cavity within the housing.

9. An optical sensor, comprising:
an optical emitter configured to emit electromagnetic radiation;
a photodiode configured to provide a photocurrent to an output node, the photocurrent responsive to a receipt of,
first portions of the electromagnetic radiation redirected by an intended target; and
second portions of the electromagnetic radiation redirected by an unintended target or received directly from the optical emitter;
a sensor circuit connected to the output node and configured to generate a sensor output; and
an optical crosstalk compensation circuit connected to at least one of the output node or the sensor circuit and configured to provide a bias to the at least one of the output node or the sensor circuit.

10. The optical sensor of claim 9, further comprising:
a controller; and
a drive circuit operable by the controller and coupled to the optical emitter; wherein,
the controller is coupled to the drive circuit and the optical crosstalk compensation circuit, the controller operable to synchronize operation of the drive circuit and the optical crosstalk compensation circuit.

11. The optical sensor of claim 9, wherein:
the sensor circuit comprises a transimpedance amplifier;
the output node is electrically connected to an input of the transimpedance amplifier; and
the optical crosstalk compensation circuit provides the bias as a bias current injected into the output node.

12. The optical sensor of claim 9, wherein the optical crosstalk compensation circuit generates the bias.

13. The optical sensor of claim 9, wherein the optical crosstalk compensation circuit comprises a voltage-to-current converter.

14. The optical sensor of claim 9, wherein the optical crosstalk compensation circuit receives the bias as an input and propagates the bias.

15. The optical sensor of claim 9, wherein the optical crosstalk compensation circuit comprises a digital-to-analog converter (DAC) having a digital input and an analog output, the analog output configured to inject the bias into the output node as a bias current.

16. A method of compensating for optical crosstalk between an optical emitter and a photodiode, comprising:
driving the optical emitter to cause the optical emitter to emit electromagnetic radiation;
receiving portions of the electromagnetic radiation at the photodiode;
generating a photocurrent responsive to the received portions of the electromagnetic radiation;
generating a bias;
compensating for the optical crosstalk between the optical emitter and the photodiode by adjusting the photocurrent using the bias; and
converting the adjusted photocurrent to a voltage.

17. The method of claim 16, wherein generating the bias comprises generating a bias current.

18. The method of claim 17, wherein adjusting the photocurrent using the bias comprises subtracting the bias current from the photocurrent.

19. The method of claim 16, further comprising:
under a no target condition,
emitting the electromagnetic radiation and receiving the portions of the electromagnetic radiation;
determining the voltage produced by converting the adjusted photocurrent differs from a calibrated value; and
calibrating the bias in response to determining the voltage produced by converting the adjusted photocurrent differs from the calibrated value.

20. The method of claim 16, further comprising:
under a no target condition,
emitting the electromagnetic radiation and receiving the portions of the electromagnetic radiation;
determining the voltage produced by converting the photocurrent differs from a calibrated value by more than a threshold amount; and
calibrating the bias in response to determining the voltage produced by converting the photocurrent differs from the calibrated value by more than the threshold amount.
